(19) United States
(12) Patent Application Publication
(10) Pub. No.: US 2023/0128719 A1
(43) Pub. Date: Apr. 27, 2023

(54) MOBILE DEVICE CHARGER COMPRISING RETENTION HOUSING

(71) Applicant: John Andrew Salley, Wilmington, NC (US)

(72) Inventor: John Andrew Salley, Wilmington, NC (US)

(21) Appl. No.: 17/879,833

(22) Filed: Aug. 3, 2022

Related U.S. Application Data
(60) Provisional application No. 63/271,340, filed on Oct. 25, 2021.

(51) Int. Cl. H02J 7/00; H02J 50/10

(52) U.S. Cl. CPC H02J 7/0044; H02J 50/10

(57) ABSTRACT

The invention is directed to a mobile device charger for use in a wide variety of environments, such as on boats, ATVs, golf carts, and the like. The charging device comprises a lower segment that attaches the charger to a supporting surface (e.g., the console of a boat). The charger also includes a middle segment and upper segment that cooperate to form a secure housing for a mobile device. Specifically, the housing includes a cutout in the middle and upper segments. Thus, the charger allows a user to charge a mobile device securely, while also protecting the device from damage due to uneven conditions (e.g., bumpy terrain). The charger also allows a user to access the mobile device while charging, such as to send an email, answer a phone call, and the like.

### CROSS-REFERENCE TO RELATED APPLICATIONS

This application claims priority to U.S. Provisional Patent Application No. 63/271,340, filed Oct. 25, 2021, the entire content of which is hereby incorporated by reference.

### TECHNICAL FIELD

The presently disclosed subject matter is generally directed to a mobile device charger that comprises a retention housing configured to charge a mobile device, while also allowing a user access to the mobile device while charging.

### BACKGROUND

Outdoor and recreational activities are increasingly popular in the United States as people continue to enjoy the use of boats, all-terrain vehicles, golf carts, and the like. The ability to conveniently charge a mobile device (e.g., phone, tablet) has become more and more desirable as the popularity, usage, and sophistication of wireless devices increase. For example, users increasingly use their mobile devices for data transmission and taking video and/or photographs, which can quickly drain battery life. While technology is continuously being explored to provide a longer device battery life, users often find the need to charge their mobile devices in situations where there is no easy charging method available. It would therefore be beneficial to provide a charging device that enables a user to charge their mobile device battery while on a boat, on a four-wheeler, or performing other outdoor activities. It would be further beneficial if the charging device allowed the user to easily access and use their mobile device while being charged, such as to send an email, answer a phone call, and/or conduct an internet search.

### SUMMARY

In some embodiments, the presently disclosed subject matter is directed to a mobile device charger comprising an upper segment defined by an open top that extends into a central cutout and an exterior lip that extends around an outer edge of the cutout. The charger also includes a middle segment comprising a series of ridges positioned on a top face, adjacent to side and bottom edges. The charger also includes a lower segment with an interior pocket that houses a charging element.

In some embodiments, the mobile device is selected from a smart phone, a tablet, a PDA, an electronic reader, or a laptop computer.

In some embodiments, the charging element is a qi charger.

In some embodiments, the device includes padded elements configured on an interior surface of the housing.

In some embodiments, the ridges include one or more textured regions.

In some embodiments, a lower edge of the charger comprises an exit for red and black DC wires.

In some embodiments, the rear surface comprises a pocket for a USB-C port.

In some embodiments, the charger includes a connection to a USB-C cable or connecting a red wire to a 12V DC positive and a black wire to a 12 DC negative or ground.

In some embodiments, the device includes one or more mounting apertures that extend from the front face of the charger to the rear face.

In some embodiments, the charger further includes a cup holder.

In some embodiments, the presently disclosed subject matter is directed to a method of charging a mobile device. Specifically, the method comprises positioning a mobile device into the housing of a charger. The housing is defined by an upper segment defined by an open top that extends into a central cutout and an exterior lip that extends around an outer edge of the cutout; a middle segment comprising a series of ridges positioned on a top face, adjacent to side and bottom edges; and a lower segment with an interior pocket that houses a charging element. The method includes charging the mobile device for a desired amount of time, wherein the mobile device can be accessed and used while charging through the open top and central cutout.

In some embodiments, the mobile device remains securely positioned within the housing during a variety of environmental conditions.

### BRIEF DESCRIPTION OF THE DRAWINGS

FIG. 1 is a perspective view of a mobile device charger in accordance with some embodiments of the presently disclosed subject matter.

FIG. 2a is a top plan view of a charger in accordance with some embodiments of the presently disclosed subject matter.

FIG. 2b is a bottom plan view of a charger in accordance with some embodiments of the presently disclosed subject matter.

FIG. 3a is a bottom plan view of a lower segment of a charger in accordance with some embodiments of the presently disclosed subject matter.

FIG. 3b is a top plan view of a lower charger segment in accordance with some embodiments of the presently disclosed subject matter.

FIG. 3c is a perspective view of a lower segment bottom face comprising adhesive strips in accordance with some embodiments of the presently disclosed subject matter.

FIG. 3d is a perspective view of a lower segment bottom face comprising a hook and loop closure in accordance with some embodiments of the presently disclosed subject matter.

FIG. 3e is a perspective view of a lower segment bottom face comprising a plurality of magnets in accordance with some embodiments of the presently disclosed subject matter.

FIG. 4a is a bottom plan view of a middle charger segment in accordance with some embodiments of the presently disclosed subject matter.

FIG. 4b is a top plan view of a middle charger segment in accordance with some embodiments of the presently disclosed subject matter.

FIG. 5a is a bottom plan view of an upper charger segment in accordance with some embodiments of the presently disclosed subject matter.

FIG. 5b is a top plan view of an upper charger segment in accordance with some embodiments of the presently disclosed subject matter.

FIG. 6a is a perspective view of a mobile device charger in accordance with some embodiments of the presently disclosed subject matter.

FIG. 6b is a perspective view of the mobile device charger of FIG. 6a in accordance with some embodiments of the presently disclosed subject matter.

FIG. 7 is a front plan view of a charger in accordance with some embodiments of the presently disclosed subject matter.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

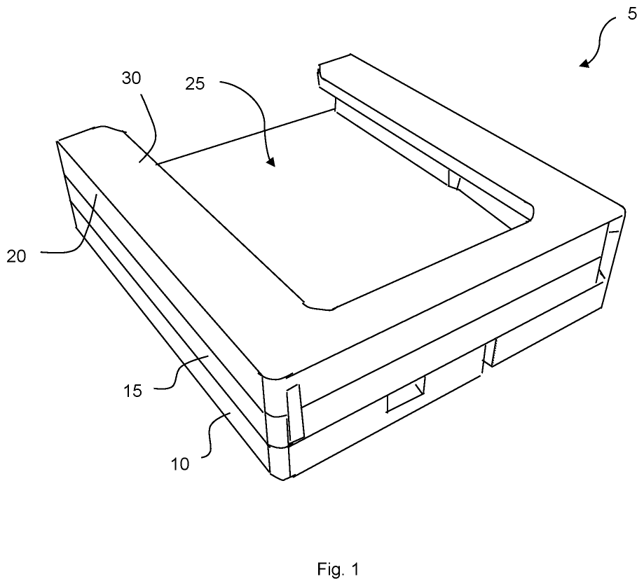

The presently disclosed subject matter is directed to a mobile device charger for use in a wide variety of indoor and outdoor environments, such as on boats, ATVs, golf carts, and the like. The term “mobile device” refers to an information processing device that can display, store, create, and/or delete data. Mobile devices suitable for use with the disclosed charger can include (but are not limited to) a smart phone, tablet, PDA, handheld computer, laptop, MP3 player, and the like. FIG. 1 illustrates one embodiment of charger 5 comprising lower segment 10 that attaches the charger to a supporting surface (e.g., the console of a boat). The charger also includes middle segment 15 and upper segment 20 that cooperate to form a secure housing for retaining a mobile device. Specifically, housing 25 is formed by a U-shaped aperture or cutout configured in the middle and upper segments. The upper segment includes lip 30 that functions to secure the mobile device within the housing so that it cannot be easily dislodged. Thus, charger 5 allows a user to charge their mobile device securely, while also protecting the device from damage due to uneven conditions (e.g., bumpy terrain). The housing cutout further allows the user to access their mobile device when needed, such as to search the internet, answer a phone call, and the like.

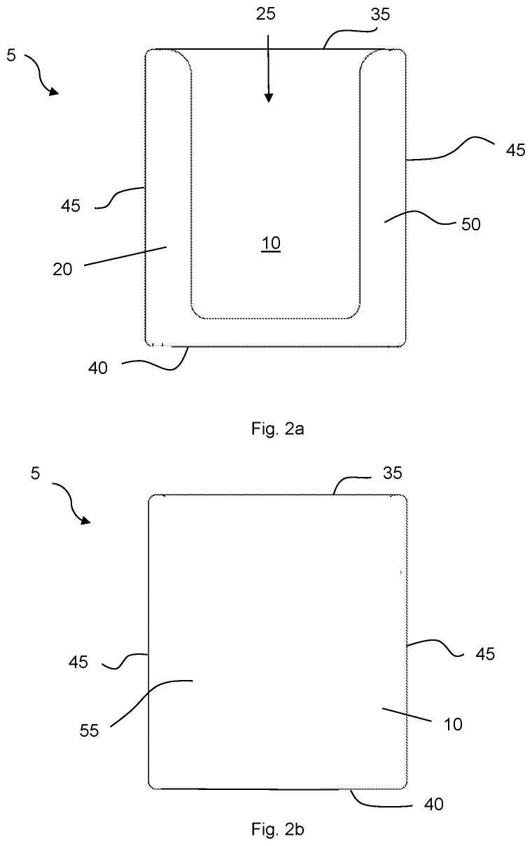

As shown in FIGS. 2a and 2b, charging device 5 includes top edge 35 and opposed bottom edge 40, a pair of side edges 45, front face 50, and opposed rear face 55. Top face 50 is formed by the uppermost face of upper segment 20. Similarly, rear face 55 can be the lowermost face of lower segment 10 (e.g., the face in contact with a support, such as a boat railing, etc.).

Although depicted as rectangular in the drawings, the charger can be configured in any desired shape, such as (but not limited to) square, rounded, oval, triangular, hexagonal, and the like. In some embodiments, the charger can be configured in a stylized design, such as in the shape of objects (e.g., flowers, cars, boats, cartoon characters).

As set forth above, lower, middle, and upper segments 10, 15, 20 are joined together to form charger 5. The term “segment” refers to a section or portion of the disclosed charger. The segments can be permanently attached together using any conventional mechanism, such as the use of adhesives, welding, thermoforming, and the like. In other embodiments, the layers can be releasably attached together through the use of screws, bolts, snap-fit closure, pressure-fit closure, magnets, and the like, allowing the charger to be disassembled for repair and/or replacement.

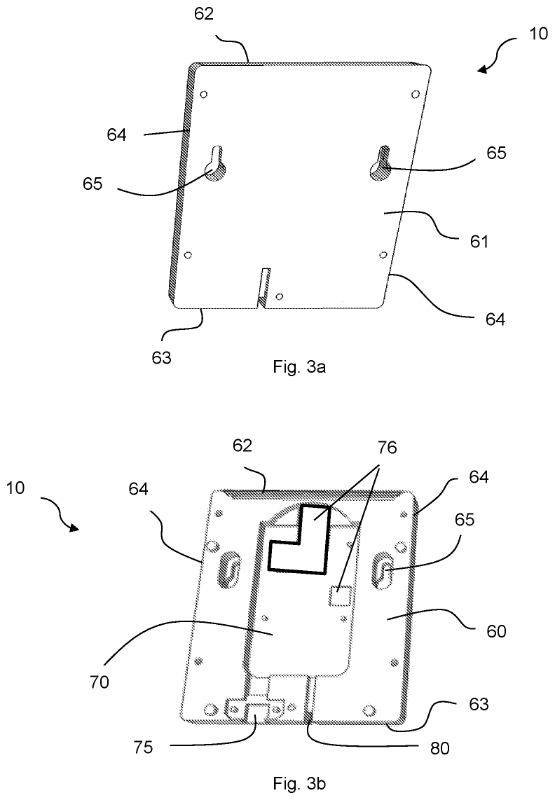

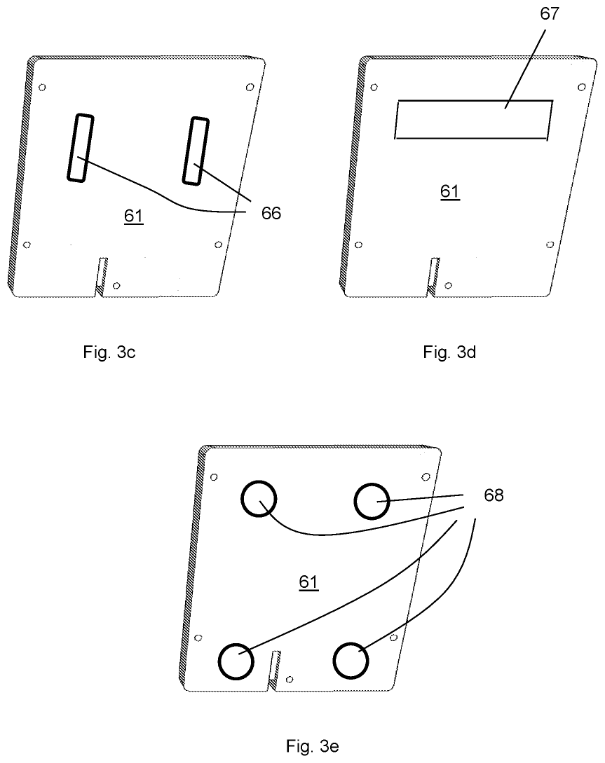

FIGS. 3a and 3b illustrate lower segment 10 top face 60 and bottom face 61 that attaches the charging device to a support surface. Top face 60 is positioned directly adjacent to the middle segment (e.g., with no intervening elements therebetween), and bottom face 61 is positioned directly adjacent to a boat console or other mounting surface. The lower segment also includes top edge 62, opposed bottom edge 63, and side edges 64.

As shown, lower segment 10 can include one or more mounts 65 used to securely position the device in a desired location. For example, the mounts can be configured as apertures that allow the device to be permanently or releasably attached to a support surface, such as with the use of screws or bolts. However, any attachment element can be used (e.g., one or more adhesive strips 66, VELCRO® strips 67, magnets 68, as shown in FIGS. 3c-3e) such that mounts 65 are optional. In some embodiments, mounts 65 pass through the lower segment (e.g., pass from the top face to the bottom face).

The top face of the lower segment further includes pocket 70 sized and shaped to accommodate a qi charger. The term “qi” refers to a wireless charging standard adopted by most major mobile device manufacturers, using indication coils built into the charger and compatible mobile devices. When a mobile device is placed in the charger, the two coils are able to temporarily act as a transformer, creating an electrical current in the coil located within the mobile device. The current flows into the battery, charging the device like a cable charger. Pocket 70 further comprises recess 76 for a diode on a qi charger. The term “pocket” can refer to a compartment or receptacle for housing a qi charger. It should further be appreciated that the presently disclosed subject matter is not limited to a pocket configured for a qi charger, and any conventional charger can be accommodated in pocket 70.

In some embodiments, the bottom surface of the lower segment includes input 75, that functions as a housing for a USB-C port and a channel that allows for wiring of the charger. Alternatively, red and black DC wires can exit the charger at outlet 80. Thus, charger 5 can be connected to charging cables present in a support surface (e.g., a USB-C cable plugged into an input).

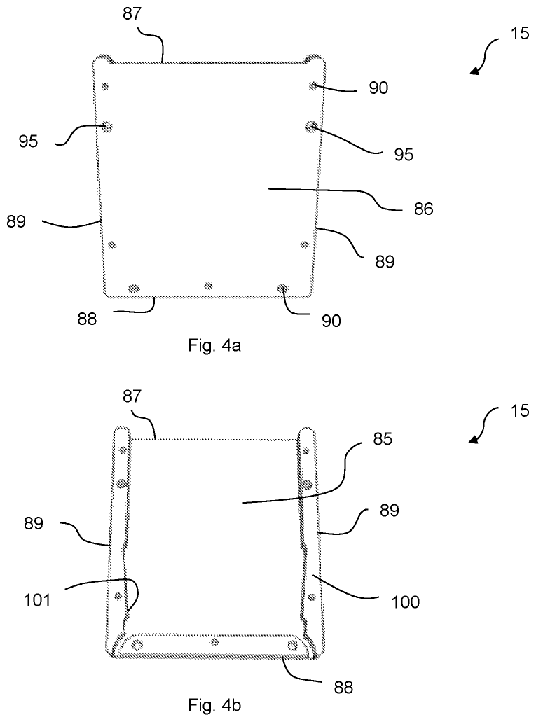

FIGS. 4a and 4b illustrate one embodiment of top face 85 and bottom face 86 of middle segment 15 of the charger. The bottom face of the middle segment directly contacts the top face of the lower segment when the charger is assembled. Similarly, the top face of the middle segment contacts the bottom face of the upper segment. Middle segment 15 also includes top edge 87, opposed bottom edge 88 and side edges 89.

As shown, the top, middle, and lower segments can include one more openings 90 to accommodate screws or bolts to connect the different segments of the device together. However, the openings are optional, and the segments can be joined using any method (e.g., the use of adhesives and the like).

The middle section can also include one or more mounting apertures 95 that align with mounts 65 on the lower segment to mount the charger to a support surface. However, the device can be mounted to a support using any method, such that apertures 95 are optional.

Top face 85 of the middle segment includes a series of raised ridges 100 positioned along the lower and side edges of the segment, as illustrated in FIG. 4b. The ridges function to create housing for holding a mobile device. For example, the ridges are raised to give the housing depth. Ridges can be constructed from any desired material, such as (but not limited to) foam, polymeric material, wood, padding, metal, and the like. The ridges can be attached using any method, such as adhesives, welding, clips, fasteners, and the like. Ridges 100 can have any desired thickness to create a housing of any depth. For example, the ridges can have thickness of about 0.1-1 inch (e.g., at least/no more than about 0.1, 0.2, 0.3, 0.4, 0.5, 0.6, 0.7, 0.8, 0.9 or 1 inch). The ridges can further include one or more textured regions 101 that function to retain the mobile device within the interior of the housing. Specifically, the textured regions can help ensure that a mobile device does not unintentionally escape the charger by gripping the side edges of the mobile device. The term “textured regions” refer to any of a variety of bumps, ridges, angled areas, jagged regions, and the like.

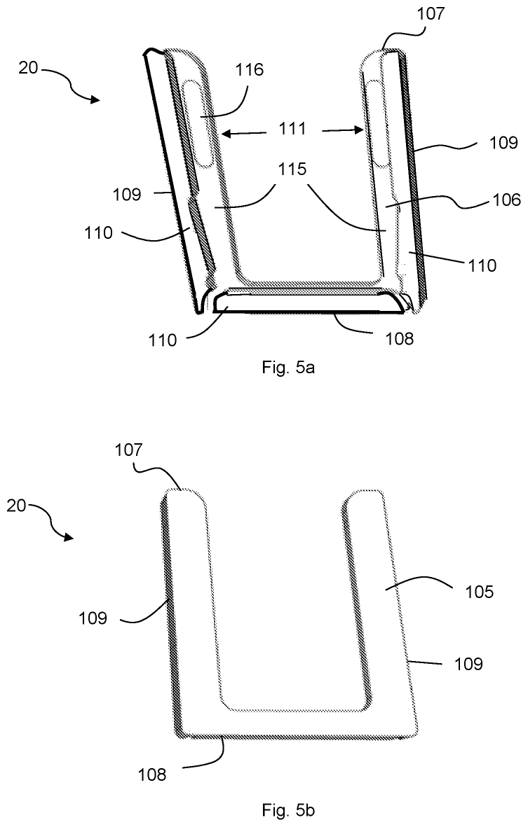

FIGS. 5a and 5b illustrate one embodiment of upper segment 20 front face 105 and rear face 106. The rear face of the upper segment directly contacts the front face of the middle segment when the charger is assembled. The front face of the upper segment forms the top of the device and is exposed to the outside environment. Upper segment 20 also includes top edge 107, opposed bottom edge 108 and side edges 109. The upper segment is formed in a U-shape with a pair of legs that extend towards top edges 107.

As shown in FIG. 5a, the rear face of the upper segment includes elevated ridges 110 configured to cooperate with the ridges present on the middle segment. For example, the ridges of the upper and middle segments can be of the same size and shape and positioned to contact each other and be overlayed (e.g., the ridge 100 positioned adjacent to the left side edge of the middle segment can directly contact ridge 110 positioned adjacent to the corresponding side edge of the upper segment). The ridges function to create housing 25 for holding a mobile device. For example, the ridges are raised to give the housing depth. Ridges 110 can be constructed from any desired material, such as (but not limited to) foam, polymeric material, wood, padding, metal, and the like. The ridges can be attached using any method, such as adhesives, welding, clips, fasteners, and the like. Ridges 110 can have any desired thickness to create a housing of any depth. For example, each ridge can have thickness of about 0.1-1 inch (e.g., at least/no more than about 0.1, 0.2, 0.3, 0.4, 0.5, 0.6, 0.7, 0.8, 0.9 or 1 inch). The upper and middle segment ridges can include a series textured regions that resist movement of the device within the charger and help ensure that the device stays in proper position.

Upper segment 20 also includes cutout 111 that provides access to the mobile device, allowing the user to activate the device touch screen to check emails, etc. The cutout is framed on the side and bottom edge with lip 115 that retains the mobile device within the housing.

In some embodiments, the device includes one or more padded elements 116 that can be applied to an interior of the upper segment lip. The padded elements can ensure a proper fit of the housing compartment for a particular mobile device (e.g., making the fit more snug if needed).

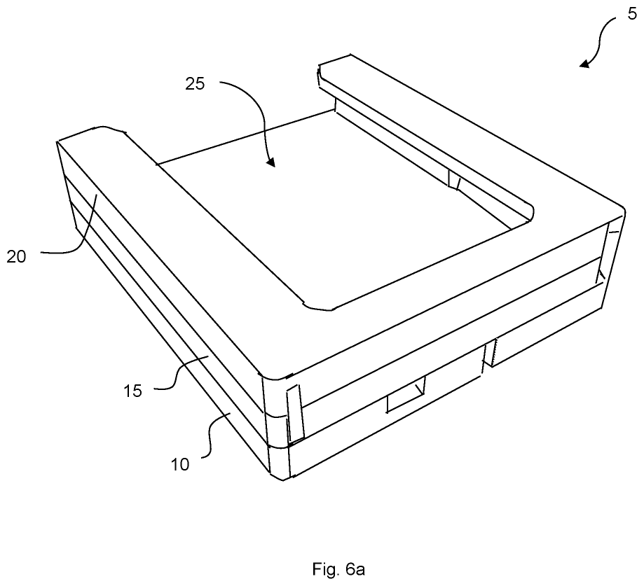

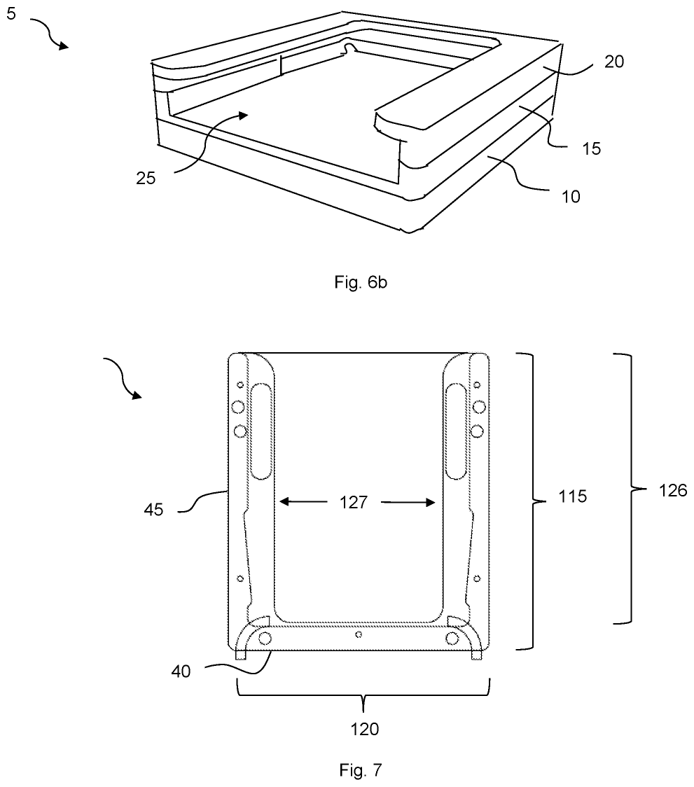

In use, the lower, middle, and upper segments are joined together using any conventional method, such as the use of adhesives, welding, magnets, ties, clips, fasteners, screws, bolts, and the like. Once assembled, the lower segment forms a foundation to the charger, and a surface to mount to a vehicle or other support surface, as shown in FIGS. 6a-6b. The middle and upper segments cooperate to form housing 25 that accommodates a mobile device. Ridges 100, 110 also function to retain the mobile device within the housing.

The disclosed charger can be configured in a variety of sizes to accommodate different types of mobile devices (e.g., a phone versus a tablet). Thus, charger 5 can include length 115 of about 3-20 inches (at least/no more than about 3, 4, 5, 6, 7, 8, 9, 10, 11, 12, 13, 14, 15, 16, 17, 18, 19, or 20 inches), as shown in FIG. 7. The term “length” refers to the longest vertical distance between top and bottom edges 35, 40 of the charger. The charger can also include width 120 of about 2-15 inches (at least/no more than about 2, 3, 4, 5, 6, 7, 8, 9, 10, 11, 12, 13, 14, or 15 inches). The term “width” refers to the longest straight line horizontal distance of the device (e.g., from one side edge to the other). The device can further include thickness 125 of about 0.25-2 inches (e.g., at least/no more than about 0.25, 0.5, 0.75, 1, 1.25, 1.5, 1.75, or 2 inches). It should be appreciated that that length, width, and thickness of the charger are not limited and can be configured outside the ranges given above.

Housing 25 can be varied depending on the particular type, make, and/or model mobile device is being charged. Thus, the housing can include thickness 130 of about 0.3-1.8 inches (e.g., at least/no more than about 0.3, 0.4, 0.5, 0.6, 0.7, 0.8, 0.9, 1, 1.1, 1.2, 1.3, 1.4, 1.5, 1.6, 1.7, or 1.8 inches). The housing can also include length and/or width 126, 127 of about 4-20 inches (at least/no more than about 4, 5, 6, 7, 8, 9, 10, 11, 12, 13, 14, 15, 16, 17, 18, 19, or 20 inches.

In some embodiments, each of the lower, middle, and upper segments has about the same length, width, and/or thickness. However, at least one segment can differ from at least one other segment by about 5-50 percent, if desired. For example, in rough environments, the lower segment may need to be thicker to provide a sturdier base support to the charger.

Charger 5 can be constructed from any desired material to withstand normal use conditions. Thus, the charger can be constructed from metal (e.g., stainless steel, copper, bronze, aluminum), polymeric material, rubber, composite materials, or combinations thereof. In some embodiments, the materials used to construct the charger are weather-resistant and/or salt-water resistant (e.g., to reduce the incidence of water damage and/or exposure to salt air/water).

In use, a mobile device can be inserted into the housing via top edge 35 of the charger. The device can slide into the housing interior such that the full length of the device is retained therein. The device is held flush against the upper and middle segments of the charger by lip 115 and/or padded elements 116. Once positioned within the housing, the screen of the mobile device can be accessed by the user.

The disclosed charger can be configured to wirelessly charge a mobile device. Wireless charging allows a user to charge a mobile device (e.g., smartphone) without the use of a charging cable. Specifically, inductive charging allows electricity to be transmitted through the air via a magnetic field. A transmitter creates an oscillating magnetic field with a receiver (the mobile device). The receiver gathers current through a special antenna that can then be stored within the mobile device battery.

For example, charger 5 can be configured as a qi wireless charger. Alternatively, the charger can be connected to charging cables present in a support surface. For instance, a USB-C cable can be plugged into input 75 on the bottom edge of the charger. In other embodiments, the red wire can be connected to a 12V DC positive, and the black wire connected to a 12V DC negative/ground.

Advantageously, charger 5 has an open face, allowing the viewing screen of a corresponding mobile device to be viewed and accessed by a user. In this way, the user can easily answer emails, phone calls, and texts without removing the device from the charger.

The charger can be powered by wiring the 12-24 VDC directly to a DC power source or fuse panel, or by plugging a USB-C cable into the port on the bottom face of the charger.

One or more optional features can also be included for use with the charger. For example, one or more adhesive pads 140 can be included, as shown in FIG. 7. The pads can be attached within the interior of the housing (e.g., on the housing-side of lip 30). The pads can provide a tight fit for a mobile device when secured with the housing.

The housing is configured to be used with a variety of device thicknesses. To this end, the device includes optional padding to customize the housing and ensure a snug fit with the device. The padding can be constructed from any suitable material, such as foam strips, and the like. The padding can have adhesive backing. Provides a soft contact on the phone's face. In this way, the housing provides a secure and snug fit for the device, ensuring that the device does not become unintentionally dislodged. At the same time, the housing allows a user to remove the mobile device using light pressure.

Because the qi charger is embedded in between the layers of the charger, it is water and water resistant.

To install the device, a hole can be drilled through a mounting surface for a power wire. Two screws can be drilled into the mounting surface, with the keyheads exposed about ⅛ of an inch. The mounts on the rear face of the charger can then slide over the keyheads and lock the device into position. The red and black wires (+ and −) can be connected to a fuse panel or other DC power source providing 9-30 volts of DC current. Alternatively, a USB-C cable can be plugged into the USB-C port on the bottom face of the charger.

Charger 5 offers many advantages over prior art phone chargers. For example, the device is versatile and can be configured in a variety of shapes and sizes to accommodate many different types of mobile devices.

The open face of the charger allows a user to access the phone when desired, while still remaining within in the charger. The user is not required to remove the mobile device before they can check their email, answer a call, or use the internet.

In addition, the charger can retain the mobile device securely within the interior of the charger housing during a variety of environmental conditions, such as on a boat in rough waters, in an ATV, etc. Ridges 100, 110 help to position the device securely, so that it cannot be dislodged from the housing if bumps occur.

The housing is also customizable using pads 140 to fit any mobile device safely within the interior of the housing.

Charger 5 can be easily used by the vast majority of people, including children and the elderly.

The disclosed charger conveniently allows user to charge their mobile devices in places away from home.

Further, the device is visually appealing, providing clean and organized look to a vehicle surface, without requiring unsightly charging cords and cables.

The charger also eliminates the problem of leaving phone chargers at home when on a boat or other vehicle.

The disclosed charger also allows a user's phone to be conveniently at hand and within reach at all times. The user does not have to locate the phone within the vehicle.

Thus, charger 5 can be used to secure and safely retain a mobile device in a wide variety of environments, such as (but not limited to) on boats, all-terrain vehicles, golf carts, RVs, cars, trucks, lawnmowers, motorcycles, bicycles, and the like.

Exemplary embodiments of the methods and components of the presently disclosed subject matter have been described herein. As noted elsewhere, these embodiments have been described for illustrative purposes only, and are not limiting. Other embodiments are possible and are covered by the presently disclosed subject matter. Such embodiments will be apparent to persons skilled in the relevant art(s) based on the teachings contained herein. Thus, the breadth and scope of the present invention should not be limited by any of the above-described exemplary embodiments but should be defined only in accordance with the following claims and their equivalents.

What is claimed is:

1. A mobile device charger comprising:
a lower segment defined by a bottom face and an opposed top face, wherein the top face includes a pocket that houses a charging element;
a middle segment comprising a bottom face and an opposed top face, a series of ridges positioned on the top face, adjacent to side and bottom edges of the middle segment, wherein the bottom face of the middle segment directly contacts the top face of the lower segment;
an upper segment defined by a bottom face and an opposed top face, wherein the bottom face comprises a series of ridges positioned adjacent to side and bottom edges of the upper segment, wherein the upper segment includes a central cutout and an open top edge that form a housing for a mobile device, and wherein the upper segment includes a lip that extends around an outer edge of the cutout.

2. The charger of claim 1, wherein the mobile device is selected from a smart phone, a tablet, a PDA, an electronic reader, or a laptop computer.

3. The charger of claim 1, wherein the charging element is a qi charger.

4. The charger of claim 1, further comprising padded elements configured on an interior surface of the housing.

5. The charger of claim 1, wherein the ridges of the upper segment and the middle segment include one or more textured regions.

6. The charger of claim 1, wherein a lower edge of the charger comprises an exit for red and black DC wires.

7. The charger of claim 1, wherein the rear surface comprises a pocket for a USB-C port.

8. The charger of claim 1 comprising a connection to a USB-C cable or connecting a red wire to a 12V DC positive and a black wire to a 12 DC negative or ground.

9. The charger of claim 1, wherein the device includes one or more mounting apertures that extend from the front face of the charger to the rear face.

10. The charger of claim 1, further comprising a cup holder.

11. A method of charging a mobile device, the method comprising:
positioning a mobile device into the housing of a charger, the housing defined by:
an upper segment defined by an open top that extends into a central cutout and an exterior lip that extends around an outer edge of the cutout;
a middle segment comprising a series of ridges positioned on a top face, adjacent to side and bottom edges;
a lower segment with an interior pocket that houses a charging element
charging the mobile device for a desired amount of time;
wherein the mobile device can be accessed and used while charging through the open top and central cutout.

12. The method of claim 11, wherein the mobile device is selected from a smart phone, a tablet, a PDA, an electronic reader, or a laptop computer.

13. The method of claim 11, wherein the charging element is a qi charger.

14. The method of claim 11, further comprising padded elements configured on an interior surface of the housing.

15. The method of claim 11, wherein the ridges include one or more textured regions.

16. The method of claim 11, wherein a lower edge of the charger comprises an exit for red and black DC wires.

17. The method of claim 11, wherein the rear surface comprises a pocket for a USB-C port.

18. The method of claim 11, wherein the mobile device is charged using a USB-C cable or connecting a red wire to a 12V DC positive and a black wire to a 12 DC negative or ground.

19. The method of claim 11, wherein the device includes one or more mounting apertures that extend from the front face of the charger to the rear face.

20. The method of claim 11, wherein the mobile device remains securely positioned within the housing during a variety of environmental conditions.
